(19) United States
(12) Patent Application Publication
(10) Pub. No.: US 2008/0247698 A1
(43) Pub. Date: Oct. 9, 2008

(54) High-Speed Movable Bearing in Particular for the Mounting of a Main Spindle of a Machine Tool

(75) Inventor: Willi Albert, Arnstein-Gaenheim (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/817,569

(22) PCT Filed: Feb. 24, 2006
(86) PCT No.: PCT/DE2006/000341

§ 371 Date: Sep. 11, 2007

(30) Foreign Application Priority Data
Mar. 4, 2005 (DE) 10 2005 009 921.1

(51) Int. Cl. F16C 19/08

(52) U.S. Cl. 384/493

(57) ABSTRACT

According to the invention, the high-speed moving bearing is embodied as an automatically-compensating movable ball bearing with several adjacent races of balls with operation-dependent radial thermal expansion of the bearing rings, the bearing rings of which are only in supporting contact with one ball race in the cold state for the high-speed movable bearing, by means of a convex embodiment of the running surfaces for the roller bodies on the inner bearing ring. With increasing thermal expansion and expansion due to centrifugal force of both bearing rings, the further ball races come sequentially into such a contact position with both bearing rings as a result of an elastic radially-flexible embodiment of both bearing rings, that the bearing rings at the operating temperature for the high-speed moving bearing are in supporting contact with all ball races.

### FIELD OF THE INVENTION

The invention relates to a high-speed movable bearing according to the features of the preamble of claim 1, which bearing can be used in particular in an advantageous manner for the mounting of the main spindle of a machine tool or for other machine parts rotating at high speed.

### BACKGROUND OF THE INVENTION

It is generally known to the person skilled in the art in the field of roller bearing technology that at least two bearings arranged at certain distances from one another are required for guiding and supporting a rotating machine part. If the shaft in this case is supported in a conventional manner in two radial bearings, the problem occurs that the distances between the bearing seats on the shaft and in the housing correspond only within the limits of the production tolerances. In addition, under operating conditions, the shaft as a rule heats up to a greater extent than the housing, such that the temperature-induced differences in length of the shaft have to be compensated for at the bearing points. The best proven means of compensating for these production tolerances and differences in length has therefore for a long time been to guide the shaft only in a fixed bearing in the axial direction, while at the other bearing point, by means of a movable bearing, the different distances are compensated for either at the seating point of the inner ring, at the seating point of the outer ring or in the bearing itself by displacing the bearing rings relative to one another. Whereas, depending on the required accuracy of the axial guidance of the shaft, in particular deep-groove ball bearings, self-aligning or taper roller bearings or also double-row or two single-row angular-contact ball bearings have proven to be especially suitable as fixed bearings of such a shaft bearing arrangement, movable bearings are most easily realized by cylindrical roller bearings or needle bearings, since, with these bearing types, a displacement of the rolling element set on the raceway of the bearing flange, which is flangeless in each case, or the shaft is possible.

However, in particular when using cylindrical roller bearings or needle bearings as movable bearings of a water-cooled main spindle of a machine tool, it has proven to be disadvantageous that these bearings mostly have high radial rigidity, which becomes apparent in increasing radial distortion in the bearing at temperature differences between inner ring and outer ring or between shaft and spindle housing due to different thermal expansion. In the process, the friction between the bearing rings and the rolling elements, which keeps on increasing due to this temperature-induced radial distortion, can become so high that, due to the friction heat produced, the admissible operating temperature of the bearing is exceeded and the requisite lubricating film between the rollers and the bearing rings separates locally until the lubricant partly burns out and the bearing fails prematurely. Although it is known that the radial play of the bearing can be appropriately preset in order to avoid such premature bearing failure, such setting of the radial play is very time-consuming via a costly tapered seat of the inner bearing ring on the main spindle of the machine tool and in addition requires very costly envelope-circle measuring instruments.

The single-row ball bearing disclosed in EP 926 368 A2 also constitutes another possibility for realizing a movable bearing in the bearing arrangement of a main spindle of a machine tool, in which ball bearing the outer race is designed with a groove-shaped ball raceway and the inner race is designed with a planar ball raceway in longitudinal section, and the bearing balls arranged between the races are made of ceramic. The design of the bearing with a defined radial clearance is intended to ensure that the bearing has both adequate seating on the shaft and in the housing, as well as favorable operating play, whereas the movable bearing function is ensured by the possibility of axial displacement of the inner bearing ring in the region of its planar running surface.

Although a ball bearing of such design counters operationally induced radial thermal expansions of the bearing rings by its defined radial clearance, it has in contrast the disadvantage that it has only a low loading capacity and thus, in crash cases, in which the bearing is suddenly subjected to extremely high concentrated loading, is prone to material damage and ultimately to total failure. In addition, it has been found in practice that even the defined radial clearance of the bearing is not sufficient to avoid overloading of the bearing in the event of a greater thermal gradient from the bearing inner ring to the bearing outer ring, such that it is not possible with such a bearing, even in double-row embodiment, to ensure uniformly precise radial spindle guidance in every operating state of the bearing.

### OBJECT OF THE INVENTION

Starting from the demonstrated disadvantages of the solutions of the known prior art, the object of the invention is therefore to conceive a high-speed movable bearing, in particular for the mounting of the main spindle of a machine tool, with which bearing it is also possible, in addition to the function of compensating for temperature-induced differences in length of the main spindle relative to its fixed bearing, to avoid overloading of the bearing resulting from operationally induced radial thermal expansions of the bearing rings and to ensure uniformly precise radial spindle guidance in every thermal and operating state of the bearing.

### DESCRIPTION OF THE INVENTION

According to the invention, this object is achieved in a high-speed movable bearing according to the preamble of claim 1 in that the high-speed movable bearing is designed as a movable ball bearing which automatically compensates for operationally induced radial thermal expansions of the bearing rings and which has a plurality of ball rows arranged side by side, and the bearing rings of which, in the cold state of the high-speed movable bearing, are in load-bearing contact with one another via merely one ball row due to a convex embodiment of the running surface for the rolling elements at the inner ring, wherein, with increasing thermal expansion, and expansion due to centrifugal force, of both bearing rings, the other ball rows, due to a radially elastically flexible design of one bearing ring or of both bearing rings, come successively into such a contact position with both bearing rings that the bearing rings come into load-bearing contact with one another via all ball rows at operating temperature of the high-speed movable bearing.

In an expedient development, the high-speed movable bearing designed according to the invention preferably has five ball rows arranged side by side and having steel or ceramic balls of the same diameter as rolling elements, of which only the rolling elements of the center ball row are in load-bearing contact with both bearing rings in the cold state of the high-speed movable bearing. The arrangement of five ball rows side by side has the advantage that external radial loads are distributed virtually uniformly to the individual ball rows and that the bearing is substantially more robust overall than known single or double-row movable ball bearings. Depending on the application, however, it is also possible to design the high-speed movable bearing with fewer than or more than five ball rows. When selecting the material and the shape for the rolling elements, in particular the use of ceramic balls has proved to be advantageous, since balls, on account of their ideal shape, can be produced more precisely than, for example, cylindrical rollers, and excellent smooth running of the movable bearing is obtained with said balls. In addition, ceramic balls, compared with ceramic cylindrical rollers, can be produced similarly cost-effective as the known balls made of a rolling contact bearing steel or the like, which can also be used as an alternative.

So that a movable bearing designed with such a number of ball rows does not need substantially more axial construction space than conventional movable bearings, it is furthermore proposed as an advantageous configuration of the high-speed movable bearing designed according to the invention to arrange the rolling elements of the individual ball rows so as to be nested one inside the other in a common bearing cage at a uniform distance apart in the circumferential direction, such that the axial width of the high-speed movable bearing is smaller than the sum of the diameters of a transverse row of five rolling elements. It has been found in practice that the axial width of a movable bearing designed with five ball rows nested one inside the other corresponds to about twice the width of the single-row movable ball bearing described in the prior art and that this does not have an adverse effect due to the axial construction space present in most applications.

In a further configuration of the high-speed movable bearing designed according to the invention, the nested arrangement can be realized in such a way that the rolling elements of the center and axially outer ball rows and the rolling elements of the two ball rows adjacent to the center ball row are arranged on common transverse axes alternately following one another in the circumferential direction. In this case, only one web is arranged between the rolling elements, arranged on a transverse axis, of the center and the axially outer ball rows, said web defining the ball pockets of the rolling elements in the bearing cage, whereas the rolling elements of the two ball rows adjacent to the center ball row, which rolling elements are likewise separated from one another only by one web defining their ball pockets in the bearing cage, are each arranged between the transverse axes of the center and the axially outer ball rows at the level of the webs defining the ball pockets of these ball rows.

In addition, a further feature of the high-speed movable bearing designed according to the invention is that five running grooves arranged side by side are incorporated as a guide for the rolling elements in the inner surface, preferably of planar design, of the outer bearing ring in accordance with the number of ball rows. These running grooves, which have a slightly larger radius than the radius of the rolling elements on account of the nestling of the rolling elements, are each designed with the same width and the same depth in cross section and merge directly into one another, such that the rolling elements are guided with about one quarter of their circumference in the running grooves.

Finally, in a further configuration of the high-speed movable bearing designed according to the invention, it is proposed that, on account of the especially high thermal gradient between the main spindle and the spindle housing of a machine tool, both bearing rings, for the radially elastically flexible design, preferably be formed at their outer surfaces with a respective annular recess which has a concave cross section and extends virtually over the entire axial width of the bearing rings and whose greatest depth corresponds approximately to half the thickness of the bearing rings. These encircling recesses in the outer surfaces of the bearing rings therefore bring about a reduction in the material cross section of the bearing rings, and this reduction in the material cross section decreases the rigidity of the bearing rings toward their axial center and at the same time increases the radial elasticity of the bearing rings toward their axial center. It has proven to be advantageous to additionally machine the surfaces of the concave annular recesses by precision grinding in order to avoid an overload fracture of the bearing rings possibly resulting from the notch effect of surface roughness. On the other hand, the axial marginal regions, adjoining the concave annular recesses, of both bearing rings are again of planar design and are preferably without a precision ground finish, such that the bearing rings can be fastened in the spindle housing and on the main spindle, respectively, without any problems via these marginal regions designed as annular bearing seats. However, in applications having a thermal gradient between the bearing rings that is not less high, it is also possible to design only the outer bearing ring or only the inner bearing ring radially elastically in said manner, such that the risk of fracture resulting from the notch effect of surface roughness does not occur in the respective other bearing ring designed in a conventional manner.

Compared with the rolling contact bearings known from the prior art, the high-speed movable bearing designed according to the invention, in particular for the mounting of the main spindle of a machine tool, therefore has the advantage that, due to the special design of its bearing rings and due to the design as a multi-row ball bearing, in addition to being able to compensate for temperature-induced differences in length of the main spindle relative to its fixed bearing seat, it is also able to automatically compensate for operationally induced radial thermal expansions, and expansions due to centrifugal force, of the bearing rings and therefore ensure uniformly precise spindle guidance in every operating and thermal state of the bearing. Due to the convex embodiment of the running surface for the rolling elements on the inner bearing ring and a corresponding design of the bearing radial clearance, precise spindle guidance is initially ensured in the cold state of the bearing via the center ball row in load-bearing contact with both bearing rings. With increasing centrifugal forces and operationally induced thermal expansions of the bearing rings, the two ball rows adjacent to the center ball row then also come into load-bearing contact with both bearing rings. Finally, if the high-speed movable bearing designed according to the invention reaches its operating temperature, the two axially outer ball rows then also come into load-bearing contact with the two bearing rings due to the radially elastically flexible design of the bearing rings, the center ball row not being overloaded and there being sufficient bearing rigidity in every thermal state of the bearing. Although the design of the high-speed movable bearing designed according to the invention as a five-row ball bearing causes slightly increased bearing friction compared with known single-row ball bearings, the suitability of this bearing for high speed is retained. At the same time, it is also achieved, for example compared with double-row cylindrical roller bearings, that the high-speed movable bearing according to the invention is substantially less sensitive to tilting of the inner bearing ring relative to the outer bearing ring. Furthermore, the high-speed movable bearing designed according to the invention is distinguished by the possibility of using non-contact sealing disks for storing lubricant, by freedom from maintenance and by low production costs due to the use of ceramic balls, which can be produced cost-effectively, instead of expensive ceramic rollers.

### BRIEF DESCRIPTION OF THE DRAWINGS

A preferred embodiment of the high-speed movable bearing designed according to the invention is explained in more detail below with reference to the attached drawings, in which:

FIG. 1 shows a cross section through the drive of a machine tool having a main spindle mounted in a fixed bearing and in a high-speed movable bearing according to the invention;

FIG. 2 shows an enlarged illustration of one half of a cross section through a high-speed movable bearing according to the invention.

### DETAILED DESCRIPTION OF THE DRAWINGS

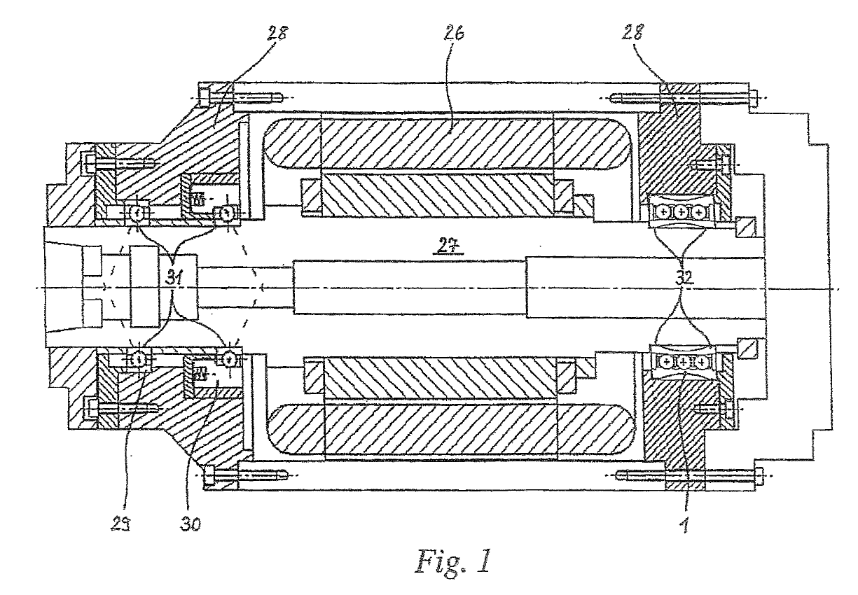

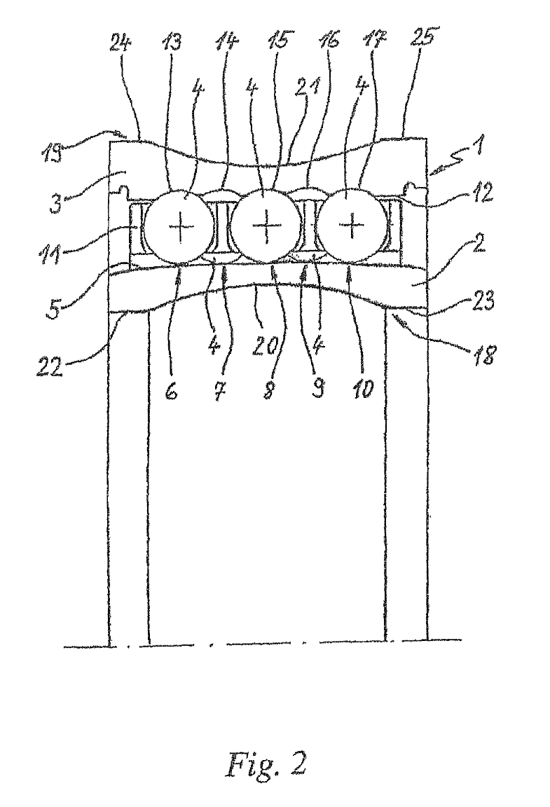

The drive of a machine tool is shown schematically in FIG. 1 and essentially comprises an electric motor 26 and a main spindle 27 driven by it. As can clearly be seen, this main spindle 27 is mounted with one end in two angular-contact ball bearings 29, 30 which are designed as a fixed bearing seat 31 inside a spindle housing 28. In contrast, the other end of the main spindle 10 is mounted in a movable bearing seat 32 which is formed by a high-speed movable bearing 1 designed according to the invention. As can be seen from FIG. 2 in this respect, this high-speed movable bearing 1 essentially comprises an inner bearing ring 2 fastened to the main spindle 27 and outer bearing ring 3 fastened in the spindle housing 28 and also a number of rolling elements 4 arranged between these bearing rings 2, 3 and has, as movable bearing function, the possibility of axial displacement of the inner bearing ring 2 in the region of its running surface 5 for the rolling elements 4.

It can also be clearly seen from FIG. 2 that the high-speed movable bearing 1 is designed according to the invention as a movable ball bearing which automatically compensates for operationally induced radial thermal expansions of the bearing rings 2, 3 and which has five ball rows 6, 7, 8, 9, 10 arranged side by side with ceramic balls of the same diameter as rolling elements 4. It can be seen from FIG. 2 merely by way of intimation that the bearing rings 2, 3, of the high-speed movable bearing 1, in the cold state of the bearing, are in load-bearing contact with one another merely via the center ball row 8 due to a convex embodiment of the running surface 5 for the rolling elements 4 at the inner bearing ring 2, whereas, with increasing thermal expansion, and expansion due to centrifugal force, of both bearing rings 2, 3, the other ball rows 6, 7, 9, 10, due to a radially elastically flexible design of both bearing rings 2, 3, successively come into a position in contact with both bearing rings 2, 3 that the bearing rings 2, 3 come into load-bearing contact with one another via all ball rows 6, 7, 8, 9, 10 at operating temperature of the high-speed movable bearing 1.

For this purpose, as can likewise be seen only by way of intimation from FIG. 2, the rolling elements 4 of the individual ball rows 6, 7, 8, 9, 10 are in each case arranged so as to be nested one inside the other in a common bearing cage 11 at a uniform distance apart in the circumferential direction, such that the axial width of the high-speed movable bearing 1 is smaller than the sum of the diameters of a transverse row of five rolling elements 4. For the nested arrangement of the ball rows 6, 7, 8, 9, 10, the rolling elements 4 of the center and axially outer ball rows 6, 8, 10 are arranged on a common transverse axis, while the rolling elements 4 of the two ball rows 7, 9 adjacent to the center ball row 8 are likewise arranged on a common transverse axis, the latter transverse axes each being arranged in the circumferential direction between the transverse axes of the rolling elements 4 of the center and the axially outer ball rows 6, 8, 10. In addition, the ball rows 6, 7, 8, 9, 10 fixed in the bearing cage 11 are axially guided between the bearing rings 2, 3 via five running grooves 13, 14, 15, 16, 17 which are arranged side by side and can clearly be seen in FIG. 2 and which are incorporated in the inner surface 12, of planar design, of the outer bearing rings 3 and which each have the same width and the same depth in cross section and are also designed with a slightly larger radius than the radius of the rolling elements 4.

Finally, it can likewise also be seen in FIG. 2 that both bearing rings 2, 3 of the high-speed movable bearing 1, for the radially elastically flexible design, are each formed at their outer surfaces 18, 19 with an annular recess 20, 21 which has a concave cross section and extends virtually over the entire axial width of the bearing rings 2, 3 and whose greatest depth corresponds approximately to half the thickness of the bearing rings 2, 3. These concave annular recesses 20, 21 in the outer surfaces 18, 19 of the bearing rings 2, 3 bring about a reduction in the material cross section of the bearing rings 2, 3, and this reduction in the material cross section decreases the rigidity of the bearing rings 2, 3 toward their axial center and at the same time increases the radial elasticity of the bearing rings 2, 3 toward their axial center. On the other hand, the axial marginal regions 22, 23, 24, 25, adjoining these annular recesses 20, 21, of both bearing rings 2, 3 are of planar design and each form annular bearing seats, via which the bearing rings 2, 3 are fastened in the spindle housing 28 and on the main spindle 27, respectively.

### LIST OF DESIGNATIONS

1 High-speed movable bearing
2 Inner bearing ring
3 Outer bearing ring
4 Rolling element
5 Running surface of 2
6 Ball row
7 Ball row
8 Ball row
9 Ball row
10 Ball row
11 Bearing cage
12 Inner surface of 3
13 Running groove
14 Running groove
15 Running groove
16 Running groove
17 Running groove
18 Outer surface of 2
19 Outer surface of 3
20 Annular recess
21 Annular recess
22 Marginal region of 18
23 Marginal region of 18
24 Marginal region of 19
25 Marginal region of 19
26 Electric motor
27 Main spindle
28 Spindle housing
29 Angular-contact ball bearing
30 Angular-contact ball bearing
31 Fixed bearing seat
32 Movable bearing seat

1. A high-speed movable bearing, the mounting of the main spindle of a machine tool, said bearing comprising an inner bearing ring fastened to the main spindle and outer bearing ring fastened in the spindle housing and also a number of rolling elements arranged between these bearing rings and has, as movable bearing function, the possibility of axial displacement of the inner bearing ring in the region of its running surface for the rolling elements, wherein the high-speed movable bearing is designed as a movable ball bearing which automatically compensates for operationally induced radial thermal expansions of the bearing rings and which has a plurality of ball rows arranged side by side, and the bearing rings of which, in the cold state of the high-speed movable bearing, are in load-bearing contact with one another via one ball row due to a convex embodiment of the running surface for the rolling elements at the inner ring, wherein, with increasing thermal expansion, and expansion due to centrifugal force, of both bearing rings, the other ball rows, due to a radially elastically flexible design of one bearing ring or of both bearing rings, come successively into such a contact position with both bearing rings that the bearing rings come into load-bearing contact with one another via all ball rows at operating temperature of the high-speed movable bearing.

2. The high-speed movable bearing as claimed in claim 1, wherein said bearing has five ball rows arranged side by side and having steel or ceramic balls of the same diameter as rolling elements, of which only the rolling elements of the center ball row are in load-bearing contact with both bearing rings in the cold state of the high-speed movable bearing.

3. The high-speed movable bearing as claimed in claim 2, wherein the rolling elements of the individual ball rows are each arranged so as to be nested one inside the other in a common bearing cage at a uniform distance apart in the circumferential direction, such that the axial width of the high-speed movable bearing is smaller than the sum of the diameters of a transverse row of five rolling elements.

4. The high-speed movable bearing as claimed in claim 3, wherein, the rolling elements of the center and axially outer ball rows and the rolling elements of the two ball rows adjacent to the center ball row are in each case arranged on common transverse axes alternately following one another in the circumferential direction.

5. The high-speed movable bearing as claimed in claim 1, wherein five running grooves arranged side by side are incorporated in the inner surface, of the outer bearing ring in accordance with the number of ball rows, which running grooves each have the same width and the same depth in cross section and are also designed with a slightly larger radius than the radius of the rolling elements.

6. The high-speed movable bearing as claimed in claim 5, wherein both bearing rings, for the radially elastically flexible design, are formed at their outer surfaces with a respective annular recess which has a concave cross section and extends virtually over the entire axial width of the bearing rings and whose greatest depth corresponds approximately to half the thickness of the bearing rings.

7. The high-speed movable bearing as claimed in claim 6, wherein the axial marginal regions, adjoining the concave annular recesses in the outer surfaces, of both bearing rings are of planar design, and the bearing rings are fastened in the spindle housing and on the main spindle, respectively, merely via these marginal regions designed as annular bearing seats.
